(19) United States
(12) Patent Application Publication
(10) Pub. No.: US 2026/0369874 A1
(43) Pub. Date: Nov. 19, 2026

(54) SYSTEM FOR MOUNTING AN ACCESSORY ON A HELMET FOR DATA COMMUNICATION

(71) Applicant: THALES, Meudon (FR)

(72) Inventors: Antoine BERNE, SAINT HEAND (FR); Dominique CHERVIN, SAINT HEAND (FR); Frédéric GUYOT, SAINT HEAND (FR)

(21) Appl. No.: 19/137,853

(22) PCT Filed: Dec. 15, 2023
(86) PCT No.: PCT/EP2023/086037

§ 371 Date: Jun. 11, 2025

(30) Foreign Application Priority Data
Dec. 16, 2022 (FR) FR2213575

(51) Int. Cl. H01Q 1/27; A42B 3/30; H01Q 9/04

(52) U.S. Cl. CPC H01Q 1/276; A42B 3/30; H01Q 9/0414

(57) ABSTRACT

A mounting system including a helmet support configured to be mounted on a helmet, an attachment assembly for removable attachment to the accessory on the helmet support, and a wireless communication device including at least one radiocommunication assembly configured for transmission of radio signals between the helmet support and the accessory, each radiocommunication assembly having a first antenna arranged on the accessory and a second antenna arranged on the helmet support.

### CROSS-REFERENCE TO RELATED APPLICATIONS

This application claims benefit under 35 USC § 371 of PCT Application No. PCT/EP2023/086037 entitled SYSTEM FOR MOUNTING AN ACCESSORY ON A HELMET FOR DATA COMMUNICATION, filed on Dec. 12, 2023 by inventors Antoine Berne, Dominique Chervin and Frédéric Guyot, PCT Application No. PCT/EP2023/086037 claims priority of French Patent Application No. 22 13575, filed on Dec. 16, 2022.

### FIELD OF THE INVENTION

This invention relates to the field of removable mounting systems for an accessory on a helmet.

### BACKGROUND OF THE INVENTION

To use night vision binoculars while being equipped with a helmet, it is possible to provide a removable mounting system comprising a helmet support fixed on the helmet, allowing selective attachment of the night vision binoculars to the helmet support for use or detachment when not in use.

The night vision binoculars are, for example, associated with an electrical system arranged on the helmet and configured to power the night vision binoculars and/or exchange data signals with them, in particular to receive images acquired by the night vision binoculars and/or send images to be displayed on the night vision binoculars and/or additional data to integrate into the images displayed by the night vision binoculars, in particular augmented reality data.

It is necessary to ensure the connection of the night vision binoculars to such an electrical system.

To do this, the electrical system can possibly be equipped with a cable equipped with a cable plug complementary to a binocular plug provided on the night vision binoculars.

To use the night vision binoculars, the user must then attach the night vision binoculars to the helmet support then connect the cable plug to the binocular plug.

Another solution consists of providing a connection device comprising a helmet connector provided on the helmet support and a binocular connector provided on the night vision binoculars, the binocular connector engaging with the helmet connector due to the mounting of the night vision binoculars on the helmet connector.

The helmet connector and the binocular connector are, for example, equipped with electrical contacts that come into contact with each other due to the mounting of the night vision binoculars on the helmet support.

It is desirable to have a mounting system that allows the connection of night vision binoculars to an electrical system arranged on the helmet in a way that is easy for the user while ensuring good connection and good water and/or dust tightness.

### SUMMARY OF THE DESCRIPTION

One of the aims of the invention is to propose a removable mounting system for an accessory on a helmet that allows a connection between the accessory and an electrical system arranged on the helmet, which is easy to use and robust.

To this end, the invention proposes a mounting system for an accessory on a helmet, the mounting system comprising a helmet support configured to be mounted on the helmet, an attachment assembly for the removable attachment of the accessory on the helmet support, and a wireless communication device comprising at least one radiocommunication assembly configured for the transmission of radio signals between the helmet support and the accessory, each radiocommunication assembly having a first antenna arranged on the accessory and a second antenna arranged on the helmet support.

Each radiocommunication assembly allows data signal exchange between the accessory and the helmet support. This allows, for example, the accessory to transmit data to the helmet support or receive data transmitted by the helmet support.

Each radiocommunication assembly is robust. In particular, each radiocommunication assembly is intrinsically resistant to dust and/or water, as data transmission is done without requiring contact between electrical contacts.

According to particular embodiments, the mounting system comprises one or more of the following optional features, taken individually or according to any technically possible combinations:
the first antenna and the second antenna of each radiocommunication assembly are directional and pointed toward each other when the accessory is mounted on the helmet support;
the first antenna and the second antenna of each radiocommunication assembly are of the horn antenna type or of the printed radiating element antenna type;
the mounting system comprises two distinct radiocommunication assemblies, one configured for the transmission of radio signals from the helmet support to the accessory and the other configured for the transmission of radio signals from the accessory to the helmet support;
the first antenna and the second antenna of one of the two radiocommunication assemblies are configured for sending and/or receiving radio waves presenting a first polarization direction, the first antenna and the second antenna of the other among the two radiocommunication assemblies being configured for sending and/or receiving radio waves presenting a second polarization direction distinct from the first polarization direction, and preferably orthogonal to the first polarization direction;
each radiocommunication assembly is configured for the transmission of radio signals by amplitude modulation of a carrier;
the carrier presents a frequency comprised between 57 GHz and 71 GHz, in particular a carrier of 60 GHz;
the mounting system comprises at least one electrical connection device, each electrical connection device comprising first contacts arranged on the accessory and second contacts arranged on the helmet support, the first contacts coming into contact with the second contacts due to the mounting of the accessory on the helmet support;
the first contacts and the second contacts comprise fixed contact pads and movable contact pistons, each contact piston coming into contact with a respective contact pad due to the mounting of the accessory on the helmet support;
the first contacts and the second contacts are arranged to come into contact according to a mounting direction of the accessory on the helmet support by translation;
the mounting system comprises a sealing device configured to ensure the seal of the electrical connection device when the first contacts are in contact with the second contacts, the sealing device comprising at least one sealing gasket provided to come in abutment with a homologous sealing surface, preferably due to the mounting of the accessory on the helmet support.

The invention also relates to a night vision system comprising night vision binoculars and a mounting system as defined above for the removable mounting of the night vision binoculars on a helmet.

### BRIEF DESCRIPTION OF THE DRAWINGS

The invention and its advantages will be better understood by reading the following description, given solely by way of non-limiting example, and made with reference to the appended drawings, in which:

FIG. 1 is a schematic side view of an assembly comprising a helmet, an electrical system carried by the helmet, an accessory, and a removable mounting system of the accessory on the helmet allowing the accessory to be linked to the electrical system;

FIG. 2 is a diagram illustrating the electrical system, the accessory, and the mounting system;

FIG. 3 is a detailed view illustrating an attachment assembly, a wireless communication device, and a contact connection device of the mounting system.

### DETAILED DESCRIPTION OF EMBODIMENTS

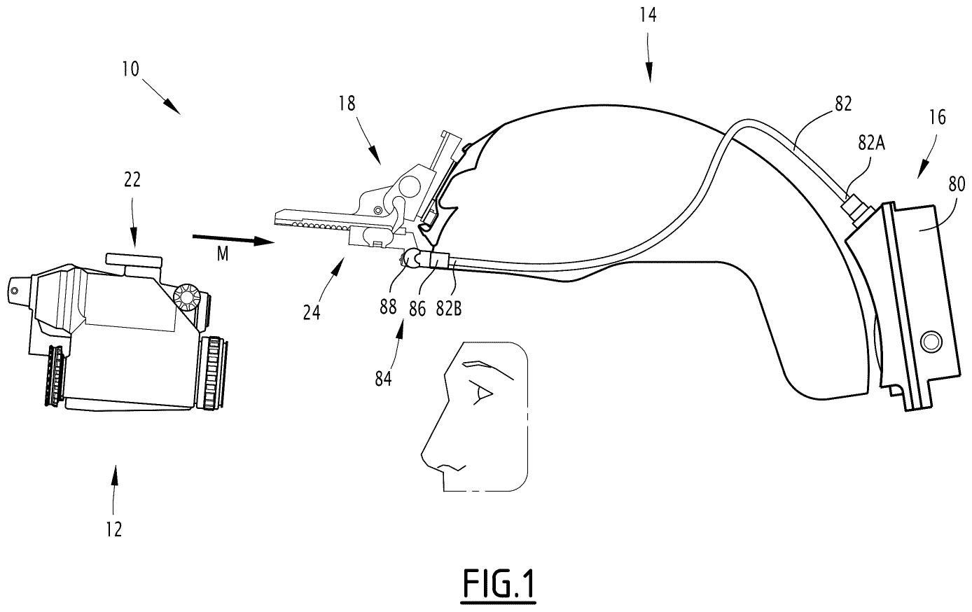

As illustrated in FIG. 1, a mounting system 10 is configured for the removable mounting of an accessory 12 on a helmet 14 with data signal transmission and, optionally, power signals, between the accessory 12 and an electrical system 16 arranged on the helmet 14.

The helmet 14 is, for example, a protective helmet, in particular a protective helmet for military, police, industrial, or sports use.

The accessory 12 is, for example, night vision binoculars.

Night vision binoculars are configured to acquire images and to display the images, possibly with the integration of augmented reality data, which are, for example, calculated by the electrical system 16 arranged on the helmet 14 and supplied to the night vision binoculars.

The mounting system 10 allows the selective mounting of the accessory 12 on the helmet 14 and the removal of the accessory 12 from the helmet 14.

The mounting system 10 comprises a helmet support 18 configured to be mounted on the helmet 14 and an attachment assembly 20 for the removable attachment of the accessory 12 on the helmet support 18.

The attachment assembly 20 comprises, for example, an accessory interface 22 arranged on the accessory 12 and a support interface 24 arranged on the helmet support 18.

The accessory interface 22 and the support interface 24 are complementary and configured to be engaged with each other (that is, mechanically engaged with each other) for the attachment of the accessory 12 on the helmet support 18, and disengagement from each other for the removal of the accessory 12 from the helmet support 18.

The attachment assembly 20 is preferably provided for quick removal of the accessory interface 22 and the support interface 24.

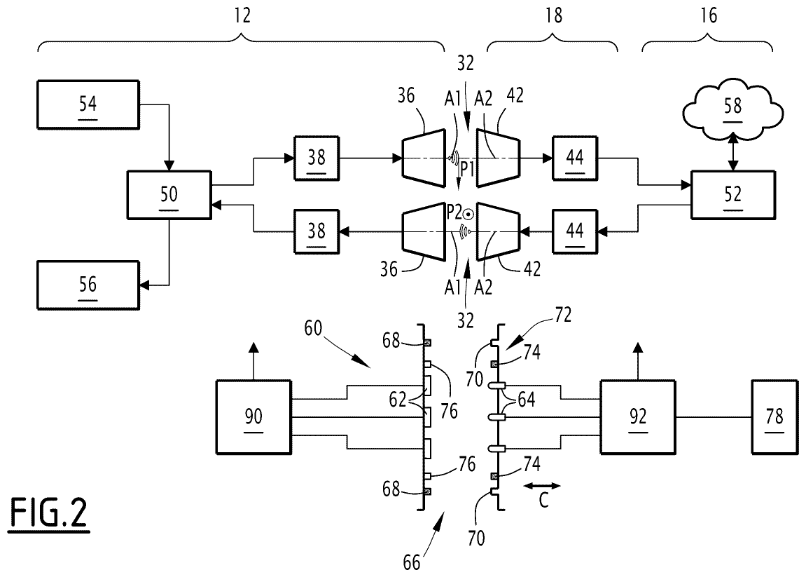

The accessory interface 22 and the support interface 24 are, for example, configured to be engaged with each other and disengaged from each other by a translation according to a mounting direction M as illustrated by an arrow in FIG. 2.

In one embodiment, one of the accessory interface 22 and the support interface 24 comprises a tenon and the other a groove, with the tenon being inserted into the groove for the engagement of the accessory interface 22 and the support interface 24.

The tenon and the groove are, for example, profiled according to the mounting direction M and present, for example, complementary dovetail profiles.

The attachment assembly 20 preferably comprises a locking device (not represented), for example, by snap-fitting, to maintain the accessory interface 22 and the support interface 24 engaged with each other.

The locking device is, for example, configured to be unlocked by the user, for example, by pressing an unlocking button or exerting sufficient disengagement force to separate the accessory interface 22 and the support interface 24 of the locking device.

As schematized in FIG. 2, the mounting system 10 comprises a wireless communication device 30 configured to ensure the wireless transmission of data signals between the accessory 12 mounted on the helmet 14 and the electrical system 16 arranged on the helmet 14.

The communication device 30 is configured to perform radiocommunication between the accessory 12 and the helmet support 18, and more particularly between the accessory interface 22 and the support interface 24 when they are engaged with each other.

By radiocommunication, we mean communication by transmitting radio waves in a medium.

The communication device 30 comprises, for example, at least one radiocommunication assembly 32 for the transmission of radiocommunication signals between the accessory 12 and the helmet support 18, each radiocommunication assembly 32 comprising:
a first sub-assembly 34 arranged on the accessory 12, in particular on the accessory interface 22, the first sub-assembly 34 comprising a first radio antenna 36 and a first radio module 38 configured to emit and/or receive radio waves by means of the first antenna 36, and
a second sub-assembly 40 arranged on the helmet support 18, in particular on the helmet interface 24, the second sub-assembly 40 comprising a second radio antenna 42 and a second radio module 44 configured to emit and/or receive radio waves by means of the second antenna 42.

The first radio module 38 is a transmitter configured to emit radio waves via the first antenna 36, a receiver configured to receive radio waves via the first antenna 36, or a transceiver configured to emit and receive radio waves via the first antenna 36.

The second radio module 44 is a transmitter configured to emit radio waves via the second antenna 42, a receiver configured to receive radio waves via the second antenna 42, or a transceiver configured to emit and receive radio waves via the second antenna 42.

Each radiocommunication assembly 32 is configured for the transmission of radiocommunication signals from the accessory 12 to the helmet support 18, for which case the first sub-assembly 34 is configured for the emission of radio waves to the second sub-assembly 40 and/or for the transmission of radiocommunication signals from the helmet support 18 to the accessory 12, for which case the second sub-assembly 40 is configured for the emission of radio waves to the first sub-assembly 34.

In the mounted state (that is, when the accessory 12 is mounted on the helmet support 18), the first antenna 36 and the second antenna 42 of each radiocommunication assembly 32 are positioned relative to each other in so as to allow the transmission of radio signals from one to the other.

The first antenna 36 and the second antenna 42 of each radiocommunication assembly 32 are, for example, directional antennas.

By “directional antenna,” it is understood, that the antenna is configured to emit radio waves propagating according to a preferred emission/reception axis and/or to receive radio waves propagating according to the preferred emission/reception axis.

Even if the antennas are directional, depending on the emission diagram of the first antenna 36 and/or the emission diagram of the second antenna 42 of each radiocommunication assembly 32, it is possible to configure the communication device 30 in such a way that in the mounted state, the emission/reception axis A1 of the first antenna 36 and the emission/reception axis A2 of the second antenna 42 are aligned or form a non-zero angle between them, while allowing the transmission of radio signals from one antenna to the other.

Preferably, in the mounted state, the emission/reception axes A1, A2 of the first antenna 36 and the second antenna 42 of each radiocommunication assembly 32 form between them an angle between 0° and 120°.

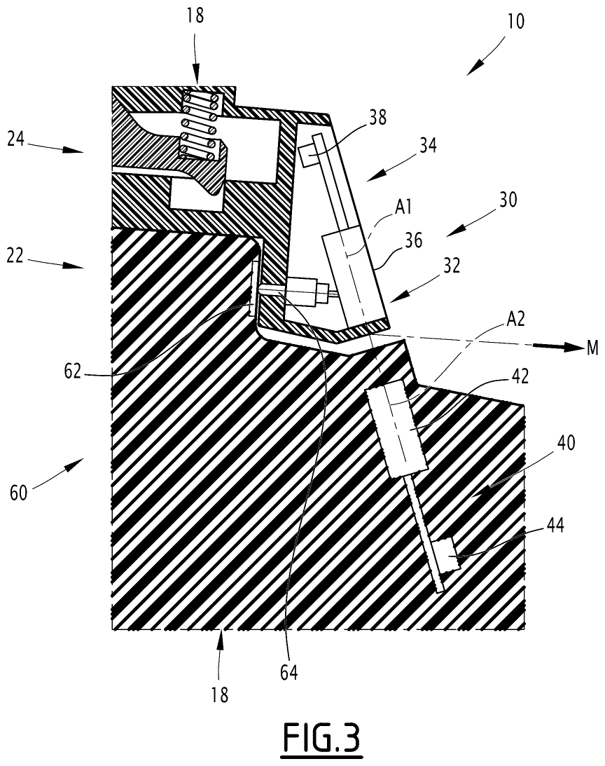

In one particular embodiment, as illustrated in FIGS. 2 and 3, in the mounted state, the emission/reception axes A1, A2 of the first antenna 36 and the second antenna 42 of one or each radiocommunication assembly 32 form a substantially zero angle between them and are therefore substantially aligned.

Alternatively, in the mounted state, the emission/reception axes A1, A2 of the first antenna 36 and the second antenna 42 of one or each radiocommunication assembly 32 form a non-zero angle between them.

The provision of a non-zero angle between the emission/reception axes A1, A2 of the first antenna 36 and the second antenna 42 of the same radiocommunication assembly 32 can be exploited to achieve a compact arrangement.

The first antenna 36 and the second antenna 42 of one or each radiocommunication assembly 32 are, for example, horn antennas.

A horn antenna is an antenna comprising a flared waveguide. The characteristics of the radio waves emitted or detectable by a horn antenna depend in part on the shape of its flared waveguide.

In particular, the polarization direction of radio waves emitted or detectable by a horn antenna depends in part on the shape of its flared waveguide.

The first antenna 36 and the second antenna 42 here respectively comprise a first flared waveguide 46 and a second flared waveguide 48.

In one alternative, the first antenna 36 and the second antenna 42 of one or each radiocommunication assembly 32 are, for example, printed radiating element antennas.

A printed radiating element antenna generally comprises a planar antenna support and printed electrical tracks on the antenna support in such a way as to define radiating elements.

A printed radiating element antenna generally presents an emission/reception axis substantially perpendicular to the antenna support on which the radiating elements are arranged.

In one embodiment, the communication device 10 is configured for simultaneous bidirectional communication, that is, to be able to transmit data simultaneously from the accessory 12 toward the helmet support 18 and from the helmet support 18 toward the accessory 12. This is referred to as “full duplex” communication according to English terminology.

The communication device 10 comprises, for example, a first radiocommunication assembly 32 configured to transmit data from the accessory 12 toward the helmet support 18 (at the top in FIG. 2) and a second radiocommunication assembly 32 configured to transmit data from the helmet support 18 to the accessory 12 (at the bottom in FIG. 2), the first radiocommunication assembly 32 and the second radiocommunication assembly 32 being distinct.

The communication device 10 thus defines two distinct radiocommunication channels, which are used to communicate each in a respective communication direction.

In one embodiment, the first antennas 36 of the two radiocommunication assemblies 32 are arranged side by side on the accessory 12 in such a way that their emission/reception axes A1 are substantially parallel and/or the second antennas 42 of the two radiocommunication assemblies 32 are arranged side by side on the support 18 in such a way that their emission/reception axes A2 are substantially parallel.

Alternatively, the first antennas 36 of the two radiocommunication assemblies 32 are arranged in such a way that their emission/reception axes A1 form a non-zero angle between them and/or the second antennas 42 of the two radiocommunication assemblies 32 are arranged on the support 18 in such a way that their emission/reception axes A2 form a non-zero angle between them.

The emission/reception axes A1, A2 of the first antennas 36 or the second antennas 42 of distinct communication assemblies forming non-zero angles between them can allow for compact arrangements to be realized.

In one particular embodiment, as illustrated in FIG. 2, the emission/reception axes A1, A2 of the first antenna 36 and the second antenna 42 of each radiocommunication assembly 32 are aligned, and the emission/reception axes A1, A2 of the first radiocommunication assembly 32 are parallel to the emission/reception axes A1, A2 of the second radiocommunication assembly 32.

Preferably, the antennas of the first communication assembly 32 are configured for the emission of radio waves having a first polarization direction P1, and the antennas of the second radiocommunication assembly 32 are configured for the emission of radio waves having a second polarization direction P2 different from the first polarization direction P1. The first polarization direction P1 and the second polarization direction P2 form a non-zero angle between them.

This allows to limit interference between the first radiocommunication assembly 32 and the second radiocommunication assembly 32.

The first polarization direction P1 and the second polarization direction P2 are preferably orthogonal.

This allows to minimize interference between the first radiocommunication assembly 32 and the second radiocommunication assembly 32 arranged side by side, in particular with the first antennas 36 having parallel emission/reception axes A1 and/or the second antennas 36 having parallel emission/reception axes A2.

In one particular embodiment, as illustrated in FIG. 2, the emission/reception axes A1, A2 of the first antenna 36 and the second antenna 42 of each radiocommunication assembly 32 are aligned, the emission/reception axes A1, A2 of the first radiocommunication assembly 32 are parallel to the emission/reception axes A1, A2 of the second radiocommunication assembly 32, the first polarization direction P1 is perpendicular to the aligned emission/reception axes A1, A2 of the antennas of the first radiocommunication assembly 32 and located in the plane of FIG. 2, and the second polarization direction P2 is perpendicular to the aligned emission/reception axes A1, A2 of the antennas of the second radiocommunication assembly 32 and perpendicular to the plane of FIG. 2.

Each radiocommunication assembly 32 is configured to perform short-distance communication, particularly communication with a range of less than 100 mm, particularly a range of less than 50 mm, particularly a range of less than 20 mm, preferably a range of less than 10 mm.

This favors the discretion of the radiocommunication assembly 12, limiting the risk of detection, particularly in military applications.

Each radiocommunication assembly 32 is configured to perform communication by amplitude modulation of a carrier, the carrier having a frequency between 20 GHz and 100 GHz, particularly a frequency between 40 GHz and 80 GHz, particularly a frequency between 57 GHz and 71 GHz.

In one particular embodiment, the carrier presents a frequency of 60 GHz.

The electrical power consumed for implementing this type of radiocommunication is low, which favors autonomy and miniaturization of the assembly.

The radio power emitted during the implementation of this type of radiocommunication is low, which favors discretion and limits the risk of detection.

The accessory 12 comprises an accessory electronic module 50 configured for data processing, and the electrical system 16 comprises a helmet electronic module 52 configured for data processing, the accessory electronic module 50 and the helmet electronic module 52 being configured to exchange data via the communication device 30.

The accessory electronic module 50 and the helmet electronic module 52 are, for example, each provided in the form of a programmable logic component, particularly in the form of a field-programmable gate array (or FPGA according to English terminology).

Alternatively, one or each of the accessory electronic module 50 and the helmet electronic module 52 is provided in the form of an electronic processing unit comprising a processor, a memory, and a software application comprising code instructions able to be stored in the memory and executable by the processor.

Alternatively, one or each of the accessory electronic module 50 and the helmet electronic module 52 is provided in the form of a specific integrated circuit (or ASIC for “Application Specific Integrated Circuit” according to English terminology).

The accessory electronic module 50 is, for example, configured to receive data from one or more electrical devices of the accessory 12 and/or to send data to one or more electrical devices of the accessory 12.

In the case of an accessory 12 such as night vision binoculars, the electrical devices of the accessory 12 comprise, for example, an image sensor 54 configured to capture images of a scene presented in front of the accessory 12 and an image display 56 configured to display images so that they are visible to the user wearing the helmet 14 when the accessory 12 is mounted on the helmet 14 using the mounting system 10.

The accessory electronic module 50 is, for example, configured to receive the images captured by the image sensor 54, to transmit the images captured by the image sensor 54 to the helmet electronic module 52 via the communication device 30, to receive data from the helmet electronic module 52 via the communication device 30, and to control the display of images on the image display 56, the images comprising, for example, a reproduction of the scene calculated from the images captured by the image sensor 54 and, optionally, data received from the helmet electronic module 52, for example, augmented reality data.

The electrical system 16 is, for example, linked to a communication system 58, for example, a communication system 58 carried by the user, the communication system 58 allowing communication with another user or a control center, for example, for sending data to another user and/or the control center and/or for receiving data from the other user and/or the control center, for example, data to be displayed on the image display 56, particularly augmented reality data.

Advantageously, the mounting system 10 comprises an electrical connection device 60 configured for the electrical connection of the accessory 12 and the helmet support 18.

The electrical connection device 60 comprises first electrical contacts 62 provided on the accessory 12, more particularly on the accessory interface 22, and second electrical contacts 64 provided on the helmet support 18, more particularly on the support interface 24.

The first electrical contacts 62 come into contact with the second electrical contacts 64 due to the mounting of the accessory 12 on the helmet support 18, more particularly due to the engagement of the accessory interface 22 and the support interface 24.

In one example, each first electrical contact 62 comes into contact with a second electrical contact 64 due to the mounting of the accessory 12 on the helmet support 18, more particularly due to the engagement of the accessory interface 22 and the support interface 24.

Each first electrical contact 62 has a homologous second electrical contact 64 with which it comes into contact due to the mounting of the accessory 12 on the helmet support 18.

When the attachment assembly 20 is configured for engagement by translation according to a mounting direction M, preferably, the electrical connection device 60 is configured in such a way that each first electrical contact 62 comes into contact with the homologous second electrical contact 64 according to the mounting direction M.

In one embodiment, in each pair of electrical contacts formed by a first electrical contact 62 and a homologous second electrical contact 64, one is fixedly mounted on the corresponding interface from among the accessory interface 22 and the support interface 24, the other being slidably mounted according to a sliding direction C on the corresponding interface from among the accessory interface 22 and the support interface 24.

When the attachment assembly 20 is configured for engagement by translation according to a mounting direction M, the sliding direction C of each sliding electrical contact is preferably parallel to the mounting direction M.

In one embodiment, each first electrical contact 62 is fixed on the accessory 12, more particularly on the accessory interface 22, and each second electrical contact 64 is slidable on the helmet support 18, more particularly on the support interface 24.

Alternatively, the configuration is reversed: each first electrical contact 62 is slidably mounted on the accessory 12, more particularly on the accessory interface 22, and each second electrical contact 64 is fixedly mounted on the helmet support 18, more particularly on the support interface 24.

Preferably, the electrical connection device 60 comprises a sealing assembly 66 comprising at least one sealing gasket configured to ensure a seal between the accessory 12 and the helmet support 18, more particularly between the accessory interface 22 and the support interface 24, around the first electrical contacts 62 and the second electrical contacts 64 when the electrical connection device 60 is engaged, preferably according to a closed line.

The electrical connection device 60 comprises, for example, a first sealing gasket 68 arranged on the accessory interface 22 around the first electrical contacts 62 and provided to come in abutment with a sealing surface 70 located on the support interface 24, preferably according to a closed line.

When the attachment assembly 20 is configured for engagement by translation according to a mounting direction M, preferably, the first sealing gasket 68 is configured to come in abutment with the sealing surface 70 of the helmet support 18 according to the mounting direction M.

Alternatively, or optionally, the electrical connection device 60 comprises, for example, a sealing gasket 72 provided on the helmet support 18 around the second electrical contacts 64 and provided to come in abutment with a sealing surface 74 provided on the accessory 12, preferably according to a closed line.

When the attachment assembly 20 is configured for engagement by translation according to a mounting direction M, preferably, the sealing gasket 72 is configured to come in abutment with the sealing surface 74 of the accessory 12 according to the mounting direction M.

The electrical connection device 60 is, for example, configured for the transmission of a power signal from the electrical system 16 carried by the helmet 14 to the accessory 12.

Optionally, the electrical connection device 60 is, for example, configured for the transmission of data signals between the accessory 12 and the electrical system 16 carried by the helmet 14.

The electrical system 16 comprises, for example, a battery 78 for powering the accessory 12, and possibly the electrical system 16 itself. The battery 78 is connected to the accessory 12 by means of the electrical connection device 60.

The electrical system 16 carried by the helmet 14 comprises, for example, a remote housing 80 connected by a connection cable 82 to the helmet support 18. The remote housing 80 contains, for example, the helmet electronic module 54 and the battery 78.

The connection cable 82 is, for example, configured for data transmission between the helmet support 18 and the remote housing 80 and/or the transmission of a power signal from the remote housing 80 to the accessory 12.

The connection cable 82 has a proximal end 82A connected to the remote housing 80 and a distal end 82B connected to the helmet support 18, preferably in a removable manner by means of a connector 84 comprising a cable plug 86 arranged at the distal end 82B and a support plug 88 arranged on the helmet support 18.

The support plug 88 is, for example, arranged laterally on one side of the helmet support 18, in such a way that the connection cable 82 connected to the helmet support 18 runs from the back of the helmet 12 to the front of the helmet 12 passing on the side of the helmet 14.

Alternatively, the support plug 88 is, for example, arranged on top of the helmet support 18, in such a way that the connection cable 82 connected to the helmet support 18 runs from the back of the helmet 12 toward the front of the helmet 12 passing over the top of the helmet 12.

The connection cable 82 comprises, for example, communication wires for carrying communication signals and power wires for carrying the power signal.

Preferably, the mounting system 10 is configured to perform communication via the connection cable 82 by low-voltage differential signaling (or SLVS for “Scalable Low-Voltage Signaling” according to English terminology).

In such a communication mode, the data is encoded by a voltage difference between two communication wires. Thus, only two communication wires are necessary in the connection cable 82, which favors lightness and miniaturization.

The accessory 12, and in particular the accessory interface 22, comprises, for example, an electrical power module 90 to which the first electrical contacts 62 are connected and which ensures the distribution of electrical energy to the electrical components of the accessory 12 and the mounting system 10, particularly to the first sub-assembly 34 of each radiocommunication assembly 32.

The electrical system 16 comprises, for example, an electrical power module 92 configured to ensure the distribution of electrical energy to the electrical components of the electrical system 16 and the mounting system 10 from the battery 78, in particular to the second sub-assembly 40 of each radiocommunication assembly 32 of the mounting system 10.

By means of the invention, it is possible to obtain a mounting system 10 for an accessory 12 on a helmet 14 that allows data signal transmission between the accessory 12 and an electrical system 16 carried by the helmet 14, the accessory 12 being easily mountable on the helmet 14, the mounting system 10 being reliable and robust.

The radiocommunication between the accessory 12 and the electrical system 16 carried by the helmet 14 performed without contact is little or not sensitive to dust and water. It does not require strong sealing against dust and/or water.

The radiocommunication between the accessory 12 and the helmet support 18 fixed to each other can be performed using low electrical power and emitting low radio power, which favors autonomy, miniaturization, and discretion.

The radiocommunication can be performed in full-duplex, allowing high data signal exchange rates, compatible, for example, with the transmission of high, very high, or ultra-high resolution images, and/or augmented reality data to be displayed on high or very high resolution or ultra-high resolution images.

The invention is not limited to the embodiments and alternatives discussed above. Other embodiments and alternatives are possible.

The radiocommunication between the accessory 12 and the helmet support 18 is not necessarily performed in full-duplex.

In one alternative, the communication device 30 comprises a radiocommunication assembly 32 configured for the transmission of data from the accessory 12 toward the helmet support 18 and for the transmission of data from the helmet support 18 toward the accessory 12.

In particular, the first radio module 38 of the radiocommunication assembly 32 is a transceiver, and the second radio module 44 of the radiocommunication assembly 32 is a transceiver.

The helmet 14 is not necessarily a military-use helmet. It can be a protective helmet for an operator, for example, a construction site operator or an industrial site operator, or a protective helmet for sports practice, for example, for the practice of an aerial sport, such as paragliding, climbing, or cycling.

The accessory 12 is not necessarily night vision binoculars. It can be binoculars (that is, daytime vision binoculars), glasses allowing data display in front of the eyes of the user, or a monocle allowing data display in front of one of the eyes of the user.

1. A mounting system for an accessory (12) on a helmet, the mounting system comprising:
a helmet support mounted on the helmet;
an attachment assembly removably attaching the accessory on said helmet support; and
a wireless communication device comprising at least one radiocommunication assembly transmitting radio signals between said helmet support and the accessory, each radiocommunication assembly comprising:
a first antenna arranged on the accessory; and
a second antenna arranged on said helmet support.

2. The mounting system according to claim 1, wherein said first antenna and said second antenna of each radiocommunication assembly are directional and pointed toward each other when the accessory is mounted on said helmet support.

3. The mounting system according to claim 1, wherein said first antenna and said second antenna of each radiocommunication assembly are of the horn antenna type or printed radiating element antenna type.

4. The mounting system according to claim 1, wherein said at least one radiocommunication assembly comprises two distinct radiocommunication assemblies, one transmitting radio signals from said helmet support toward the accessory and the other transmitting radio signals from the accessory toward said helmet support.

5. The mounting system according to claim 4, wherein said first antenna and said second antenna of one of said two radiocommunication assemblies send and/or receive radio waves presenting a first polarization direction, said first antenna and said second antenna of the other from among said two radiocommunication assemblies sending and/or receiving radio waves presenting a second polarization direction distinct from the first polarization direction.

6. The mounting system according to claim 1, wherein each radiocommunication assembly of transmits radio signals by amplitude modulation of a carrier.

7. The mounting system according to claim 6, wherein the carrier presents a frequency between 57 GHz and 71 GHz.

8. The mounting system according to claim 1, further comprising at least one electrical connection device, each electrical connection device comprising:
first contacts arranged on the accessory; and
second contacts arranged on said helmet support, said first contacts coming into contact with said second contacts due to the mounting of the accessory on said helmet support.

9. The mounting system according to claim 8, wherein said first contacts and said second contacts comprise:
fixed contact pads; and
movable contact pistons, each contact piston coming into contact with a respective contact pad due to the mounting of the accessory on said helmet support.

10. The mounting system according to claim 8, wherein said first contacts and said second contacts come into contact according to a mounting direction of the accessory on said helmet support by translation.

11. The mounting system according to claim 8, further comprising a sealing device ensuring sealing of said at least one electrical connection device when said first contacts are in contact with said second contacts, the sealing device comprising at least one sealing gasket provided to come in abutment with a homologous sealing surface.

12. A night vision system comprising night vision binoculars and a mounting system according to claim 1, removably mounting the night vision binoculars on the helmet.

13. The mounting system according to claim 4, wherein said first antenna and said second antenna of one of said two radiocommunication assemblies send and/or receive radio waves presenting a first polarization direction, said first antenna and said second antenna of the other from among said two radiocommunication assemblies sending and/or receiving radio waves presenting a second polarization direction orthogonal to the first polarization direction.

14. The mounting system according to claim 6, wherein the carrier presents a frequency of 60 GHz.

15. The mounting system according to claim 11, wherein said at least one sealing gasket is provided to come in abutment with a homologous sealing surface due to the mounting of the accessory on the helmet support.
